(19) United States
(12) Patent Application Publication
(10) Pub. No.: US 2025/0058319 A1
(43) Pub. Date: Feb. 20, 2025

(54) A MICROFLUIDIC SYSTEM

(71) Applicant: miDiagnostics NV, Heverlee (BE)

(72) Inventor: David MIKAELIAN, Heverlee (BE)

(21) Appl. No.: 18/725,408

(22) PCT Filed: Dec. 29, 2022
(86) PCT No.: PCT/EP2022/088031

§ 371 Date: Jun. 28, 2024

(30) Foreign Application Priority Data
Dec. 29, 2021 (EP) 21218099.6

(51) Int. Cl. B01L 3/00; B01F 33/30; B01F 35/71

(52) U.S. Cl. CPC B01L 3/502746; B01F 33/3035; B01F 35/715; B01L 3/502738; B01L 2200/0605; B01L 2200/0621; B01L 2200/16; B01L 2300/047; B01L 2300/0867; B01L 2400/0406; B01L 2400/0688

(57) ABSTRACT

The present inventive concept relates to a microfluidic system (10) for diluting a sample liquid of a predetermined sample volume. The system (10) comprises: a first sample channel (100) ending in a first valve (110), wherein the first sample channel (100) is arranged to contain the sample liquid of the predetermined volume; a buffer reservoir (120) arranged for receiving a buffer liquid; a timing channel (102) connecting the buffer reservoir (120) and the first valve (110), wherein the timing channel (102) is arranged to draw, by capillary action, buffer liquid from the buffer reservoir (120) to an output (1102) of the first valve (110) and to open the first valve (110), whereby sample liquid present in the first sample channel (100) is allowed to flow through the output (1102) of the first valve (110) together with buffer liquid from the timing channel (102); a buffer channel (104) connecting the buffer reservoir (120) and a second valve (112), wherein the buffer channel (104) is arranged to draw, by capillary action, buffer liquid from the buffer

### TECHNICAL FIELD

The present inventive concept relates to a microfluidic system and a diagnostic device comprising a microfluidic system. The present inventive concept further relates to a method for diluting a sample liquid of a predetermined sample volume.

### BACKGROUND OF THE INVENTION

Microfluidics deal, among other things, with control of fluids that are geometrically constrained to small scales. Such technology is commonly used within ink-jet printer heads, DNA analysis chips, as well as for other types of “lab-on-a-chip” applications. In many applications, passive fluid control is used, which may be realized by utilizing capillary action that can arise within tubes having sub-millimeter dimensions.

Such systems may be used when measurement and control of volumes is needed, for example in blood cell differentiation or counting, where the volume of the blood sample processed must be known with high accuracy. In a system where a relatively large blood sample (>10 μl) is added, it may not be desirable to process the entire sample of blood since only a minute quantity (<10 μl) is needed to get accurate statistics on the blood cell make-up or distribution. Therefore, the sampling systems need to measure a known quantity of blood from the sample for processing. Typically, the sample is diluted prior before it is analyzed, for example by mixing with a buffer liquid. The mixing is usually done by connecting two channels and letting the sample and buffer flow through their respective channels. The dilution of the combined liquid is then determined by the relative flow rates between the two channels. The degree of dilution needed varies depending on the specific application. For example, for blood cell counting, the sample is typically highly diluted, e.g. by dilution with buffer liquid.

However, when producing a highly diluted liquid, the flow rate in the channel carrying buffer liquid can become very high. This, in turn, can be problematic since the channels are often connected to a stop valve in order to properly control the mixing process and thereby avoid an inconsistent dilution. In case the flow rate is too high in a connecting channel, the stop valve will not be able to properly stop that flow leading to an uncontrolled mixing. Thus, there exists a need of an improved system capable of providing a sample which is highly diluted with a buffer.

### SUMMARY OF THE INVENTION

It is an object to, at least partly, mitigate, alleviate, or eliminate one or more of the above-identified deficiencies in the art and disadvantages singly or in any combination and solve at least the above-mentioned problem.

According to a first aspect a microfluidic system is provided. The microfluidic system comprising: a first sample channel ending in a first valve, wherein the first sample channel is arranged to contain the sample liquid of the predetermined volume; a buffer reservoir arranged for receiving a buffer liquid; a timing channel connecting the buffer reservoir and the first valve, wherein the timing channel is arranged to draw, by capillary action, buffer liquid from the buffer reservoir to an output of the first valve and to open the first valve, whereby sample liquid present in the first sample channel is allowed to flow through the output of the first valve together with buffer liquid from the timing channel; a buffer channel connecting the buffer reservoir and a second valve, wherein the buffer channel is arranged to draw, by capillary action, buffer liquid from the buffer reservoir to a first opening of the second valve; and a mixture channel connecting the first valve and the second valve, wherein the mixture channel is arranged to draw, by capillary action, liquid from the first valve to a second opening of the second valve; wherein the second valve is arranged to be opened when liquid has been drawn to the first opening or the second opening of the second valve, whereby liquid is allowed to flow between the first opening, the second opening, and a third opening of the second valve, thereby allowing the sample liquid of the predetermined volume to be diluted with buffer liquid.

The sample liquid may be blood and/or plasma. A viscosity of the sample liquid may be within a range from 1 cP to 10 cP (0.001 Pa×s to 0.01 Pa×s).

The buffer liquid may be a saline solution and/or aqueous buffer. A viscosity of the buffer liquid may be within a range from 0.5 cP to 1.5 cP (0.0005 Pa×s to 0.0015 Pa×s), such as 1 cP (0.001 Pa×s).

It is to be understood that the liquids and viscosities listed above are examples only, and that the present microfluidic system may be configured for other liquids/viscosities as well.

By means of the present inventive concept, a high dilution of the sample liquid is allowed. Put differently, by means of the present microfluidic system, the sample liquid of the predetermined volume is allowed to be diluted with buffer liquid to a high extent while flow rates of channels connecting to the valves are allowed to be low enough for the first and second valves to function properly, whereby a controlled mixing process is allowed.

Mixing in the present context is used for describing that separate flows of liquid are combined or contacted at or adjacent to a valve. Mixing is not necessarily used for describing achieving a complete mixture of the liquids. The combined liquids may proceed to mix as they flow along a channel downstream of a valve, such as, for example, assisted by diffusion or convection.

In the above microfluidic system, the sample liquid is mixed with buffer liquid in two instances. The first mixing occurs at the first valve, and the dilution ratio at this point is determined by relative flow rates of the first sample channel and the timing channel. Where the second mixing occurs depends on the configuration of the second valve, and the relative flows in connecting channels. Generally, the flow rate of a liquid in a channel depends on a geometry and/or dimensions of the channel, and the viscosity of the liquid.

In a first variant, the microfluidic system may further comprise a first exit channel connected to the third opening of the second valve. In this first variant, the second valve is configured, in its closed state, to stop liquid from the mixture channel, and to open in response to receiving liquid from the buffer channel. Alternatively, in this first variant, the second valve is configured, in its closed state, to stop liquid from the buffer channel, and to open in response to receiving liquid from the mixture channel. In this first variant, the second valve is further configured, in its open state, to allow liquid from the mixture channel to mix with buffer liquid from the buffer channel and to flow to the first exit channel. Therefore, in this variant, the microfluidic system outputs sample liquid mixed with buffer liquid via the first exit channel.

In a second variant, the microfluidic system may further comprise: an outlet channel connecting an outlet point of the buffer channel to an outlet, wherein the outlet point of the buffer channel may be between the buffer reservoir and the second valve. In the second variant, the second valve may be configured, in its closed state, to stop liquid from the buffer channel, and to open in response to receiving liquid from the mixture channel. Alternatively, in this second variant, the second valve may be configured, in its closed state, to stop liquid from the mixture channel, and to open in response to receiving liquid from the buffer channel. In the second variant, the second valve may be further configured, in its open state, to allow liquid from the mixture channel to flow to the outlet channel via the buffer channel. Hence, in this second variant, the mixing of sample liquid with buffer liquid may occur predominantly at the outlet point. The mixing of sample liquid with buffer liquid may depend on the flow rate in the portion of the buffer channel between the buffer reservoir and the outlet point and the flow rate in the portion of the buffer channel between the outlet point and the second valve. In other words, the second valve together with the flow resistance of the mixture channel may be configured such that liquid from the mixture channel flows, when the second valve is in its open state, to the outlet channel via the buffer channel. Therefore, in this second variant, the microfluidic system may output sample liquid mixed with buffer liquid via the outlet channel.

An associated advantage is that a flow resistance of a portion of the buffer channel between the buffer reservoir and the outlet point may be reduced, which may lead to a high dilution ratio of liquid flowing through the output channel, while a flow resistance of a portion of the buffer channel between the outlet point and the second valve may be increased whereby the flow from the buffer channel may be stopped at the second valve.

The first exit channel may connect the second valve to a third valve, wherein the third valve may be connected to a first vent, wherein the first vent may be arranged to allow gaseous communication between the third valve and surroundings of the microfluidic system such that gas present in the first exit channel may be allowed to escape.

An associated advantage is that liquid entering the first exit channel may be stopped at the third valve. Hence, an amount of sample liquid mixed with buffer liquid that enters the first exit channel from the mixture channel may be reduced by arranging the third valve close to the second valve. This, in turn, may allow a major portion of the sample liquid mixed with buffer liquid in the mixture channel to enter the buffer channel in response to the second valve being opened.

A further associated advantage is that an improved liquid flow through the channels may be allowed, since a build-up of gaseous pressure in the channels acting against the capillary action of the channels may be avoided.

The buffer channel may comprise: a first portion extending between the buffer reservoir and the outlet point of the buffer channel; and a second portion extending between the second valve and the outlet point of the buffer channel; wherein a flow resistance of the first portion may be between 0.1 and 0.9 times a flow resistance of the second portion.

An associated advantage is that a more refined (e.g., higher) dilution ratio of the sample liquid with buffer liquid may be allowed. In particular, since the flow resistance of the first portion may be lower than the flow resistance of the second portion, a flow rate of liquid in the buffer channel when it reaches the second valve may be low enough for the second valve to function properly (i.e., stopping liquid flow from the buffer channel) while, at the same time, allowing for a higher flow rate of liquid in the first portion. As an illustrative example, the flow rate in the first portion may exceed the flow rate at which the second valve cannot stop the liquid flow from the connecting channel. This may, in turn, allow for an even higher dilution when the sample liquid mixed with buffer liquid from the mixture channel is mixed with buffer liquid at the outlet point and output to the outlet channel.

The microfluidic system may further comprise: a sample reservoir arranged for receiving a sample liquid; a second sample channel connected to the sample reservoir, the second sample channel branching off into a third sample channel ending in a fourth valve, and into a fourth sample channel, the fourth sample channel branching off into a fifth sample channel ending in a fifth valve, and into the first sample channel; a first trigger channel arranged to connect the buffer reservoir to the fifth valve; a second trigger channel connecting the fifth valve and the fourth valve; and a second exit channel having a first end and a second end, wherein the first end may be connected to the fourth valve; wherein the second sample channel may be arranged to draw sample liquid from the sample reservoir to fill the second, third, fourth, fifth, and first sample channels by capillary action; wherein the first trigger channel may be arranged to draw buffer liquid from the buffer reservoir, by capillary action, to the second exit channel via a fluid path comprising the second trigger channel, and to open the fifth valve and the fourth valve, whereby a further fluid path comprising the fifth sample channel, the fourth sample channel, and the third sample channel may be opened up, allowing for sample present in the fifth sample channel, the fourth sample channel, and the third sample channel to be replaced by buffer liquid from the first trigger channel and flow into the second exit channel together with buffer liquid from the second trigger channel, thereby isolating a sample liquid present in the first sample channel from adjacent sample liquid, wherein a volume of the isolated sample liquid may correspond to the volume of the first sample channel, whereby the first sample channel may receive the sample liquid of the predetermined volume.

An associated advantage is that a single microfluidic system capable of metering a sample liquid of a predetermined volume and diluting the metered sample liquid of the predetermined volume is allowed. This may, in turn, allow for a less complex system consisting of separate parts. Such system may, for example, be easier and/or less expensive to manufacture.

A further associated advantage is that a metered volume of the sample fluid may be provided. In particular, the sample having the predetermined volume may be provided by a microfluidic system utilizing capillary action without actively controlling the flows within the system. It is typically problematic to stop flows arising from capillary action, and it may therefore be advantageous to meter the sample having the predetermined volume by means of the present microfluidic system.

Further, an analysis of the sample fluid having the predetermined volume may be enhanced, since the volume of the sample fluid is accurately known (i.e., the predetermined volume may correspond to the volume of the first sample channel).

The timing channel may be configured to open the first valve subsequent to the sample liquid present in the first sample channel being isolated from adjacent sample liquid.

An associated advantage is that the volume of the sample fluid flowing through the output of the first valve may be more precisely determined, since sample fluid adjacent to the isolated sample fluid may not flow through the output of the first valve. Hence, the volume of the sample fluid contained in the first sample channel may be more precisely metered.

The timing channel may comprise a first flow resistor, wherein a flow resistance of the first flow resistor may be selected to control the flow rate from the buffer reservoir to the first valve such that the first valve may be opened subsequent to sample liquid in the first sample channel being isolated from adjacent sample liquid.

An associated advantage is that a length of the timing channel may be decreased, while still allowing for the first valve to be opened subsequent to the sample fluid in the first sample channel being isolated from adjacent sample fluid.

The microfluidic system may further comprise: a capillary pump arranged to empty the sample reservoir.

An associated advantage is that the sample reservoir may receive sample fluid having a larger volume than a combined volume of the first, second, third, fourth, and fifth sample channels, whereby a need to limit the volume of the sample fluid received by the sample reservoir may be reduced. In case sample fluid is present in the sample reservoir subsequent to filling the first, second, third, fourth, and fifth sample channels, additional sample fluid may be drawn by capillary action from the sample reservoir upon opening one of the first valve, the fourth valve, and the fifth valve.

The capillary pump may be connected to the sample reservoir via a second flow resistor, wherein a flow resistance of the second flow resistor may be selected to control the flow rate from the sample reservoir to the capillary pump such that the sample reservoir may be emptied subsequent to the second sample channel, the third sample channel, the fourth sample channel, the fifth sample channel, and the first sample channel being filled with sample fluid.

An associated advantage is that the volume of the sample fluid flowing through the output of the first valve may be more precisely determined, since the sample reservoir is not emptied prior to the first sample channel being filled with sample fluid. Hence, the volume of the sample fluid to be diluted may be more precisely metered.

The microfluidic system may further comprise: a stop valve connected to the second end of the second exit channel.

The microfluidic system may further comprise: a second vent connected to the stop valve, wherein the second vent may be arranged to allow gaseous communication between the stop valve and surroundings of the microfluidic system such that gas present in the second exit channel may be allowed to escape.

An associated advantage is that an improved flow of the sample fluid and/or the buffer fluid may be allowed, since a build-up of gaseous pressure in the channels acting against the capillary action of the channels may be avoided.

One or more walls of the channels may comprise one or more of: silica, glass, a polymeric material, polycarbonate, silicon, poly(methyl methacrylate) (PMMA), polydimethylsiloxane (PDMS), and cyclic olefin copolymer (COC).

The timing channel may connect the buffer reservoir and the first valve via a sixth valve, and the microfluidic system may further comprise: a dilution channel connecting the buffer reservoir and the sixth valve, the dilution channel being configured to draw, by capillary action, buffer liquid from the buffer reservoir to the sixth valve; and wherein the timing channel may be further configured to open the sixth valve, whereby buffer liquid may be allowed to flow from the dilution channel to the first valve.

An associated advantage is that a dilution of the sample fluid flowing through the output of the first valve may be controlled by adjusting the flow rate in the dilution channel and the channel connecting the sixth valve and the first valve.

According to a second aspect a diagnostic device is provided. The diagnostic device comprises a microfluidic system according to the first aspect.

The above-mentioned features of the first aspect, when applicable, apply to this second aspect as well. In order to avoid undue repetition, reference is made to the above.

According to a third aspect a method for diluting a sample liquid of a predetermined sample volume is provided. The method comprising: providing the sample liquid of the predetermined volume to a first sample channel, wherein the first sample channel ends in a first valve; and providing a buffer liquid to a buffer reservoir, whereby buffer liquid is drawn, by capillary action, from the buffer reservoir via a buffer channel to a first opening of a second valve, and from the buffer reservoir via a timing channel to the first valve, wherein the first valve is opened by the buffer liquid and whereby the sample liquid of the predetermined volume and the buffer liquid flow to a second opening of the second valve via a mixture channel; wherein the second valve is opened upon receiving liquid at the first opening or the second opening, whereby liquid communication is allowed between the first opening, the second opening, and a third opening of the second valve.

The above-mentioned features of the first and/or second aspects, when applicable, apply to this third aspect as well. In order to avoid undue repetition, reference is made to the above.

A further scope of applicability of the present disclosure will become apparent from the detailed description given below. However, it should be understood that the detailed description and specific examples, while indicating preferred variants of the present inventive concept, are given by way of illustration only, since various changes and modifications within the scope of the inventive concept will become apparent to those skilled in the art from this detailed description. Hence, it is to be understood that this inventive concept is not limited to the particular steps of the methods described or component parts of the systems described as such method and system may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

### BRIEF DESCRIPTION OF THE DRAWINGS

The above and other aspects of the present inventive concept will now be described in more detail, with reference to appended drawings showing variants of the inventive concept. The figures should not be considered limiting the inventive concept to the specific variant; instead, they are used for explaining and understanding the inventive concept. As illustrated in the figures, the sizes of layers and regions are exaggerated for illustrative purposes and, thus, are provided to illustrate the general structures of variants of the present inventive concept. Like reference numerals refer to like elements throughout.

FIG. 1 illustrates a microfluidic system for diluting a sample liquid of a predetermined sample volume.

FIG. 2 illustrates a second variant of the microfluidic system of FIG. 1.

FIG. 3 illustrates a single microfluidic system capable of metering a sample liquid of a predetermined volume and diluting the sample liquid with buffer liquid.

FIG. 4 is a block scheme of a method for diluting a sample liquid of a predetermined volume.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

It is to be understood that the channels of the microfluidic systems described below are capillary channels. A capillary channel is a channel capable of providing a capillary-driven flow of a liquid present inside the channel.

In the following, fluid is described as flowing through channels and reaching certain positions at different times within the microfluidic system. Flow rates of these flows may be controlled in different manners in order for the fluid to reach the positions at the described times. A capillary-driven flow of a fluid requires one or more contacting surfaces that the fluid can wet. For example, surfaces comprising glass or silica may be used for capillary-driven flows of aqueous liquids. Further, for example, suitable polymers with hydrophilic properties, either inherent to the polymer or by modification, including for example chemical modification or coating, may promote or enhance capillary driven flows.

The flows may be controlled, for example, by adapting the length of the channels and/or by adapting the flow resistances of the channels. The flow resistance of a channel may be controlled by adapting a cross-sectional area of the channel and/or the length of the channel. The flow resistance of a channel may further be dependent on properties of the liquid, e.g. its dynamic viscosity. Additionally, or alternatively, the flow rate may be adapted by using flow resistors. A flow resistor may be a channel with a defined flow resistance in a flow path of the liquid.

Capillary-driven flows, in addition to being dependent on materials of surfaces, may be dependent on the liquid flowing. Attractive forces between the liquid and surfaces of channels may have an effect on a capillary-driven flow. Further, capillary-driven flows may be controlled, for example, by adapting one or more of: dimensions (e.g., one or more of length, width, and depth) of the channels; the flow resistances of the channels; and capillary driving forces and/or pressures. The flow resistance of a channel may, as indicated above, further be dependent on properties of the liquid, e.g. its dynamic viscosity.

To provide desired capillary forces, dimensions of flow channels may be selected dependent on, for example, one or more of: properties of the liquid; material of walls of the channels; and properties of walls of the channels.

The flow through the microfluidic systems may further be controlled by using valves. It is to be understood that one or more valves of the microfluidic system may be trigger valves. A trigger valve may, in its closed state, stop a main fluid flow, and in its opened state, allow the main fluid flow to pass through the trigger valve. The trigger valve may be opened (i.e., changed to its opened state) by a secondary flow, and a combined flow of the main flow and the secondary flow may be allowed to flow through an output of the trigger valve. Such trigger valves may within the art be known as capillary trigger valves. In case the secondary fluid flow reaches the trigger valve prior to the main fluid flow, the trigger valve may allow the secondary fluid flow to flow through the trigger valve. Since the trigger valve in such case is already in its opened state, the trigger valve may, upon receiving the main fluid flow, allow the combined fluid flow to flow through the trigger valve.

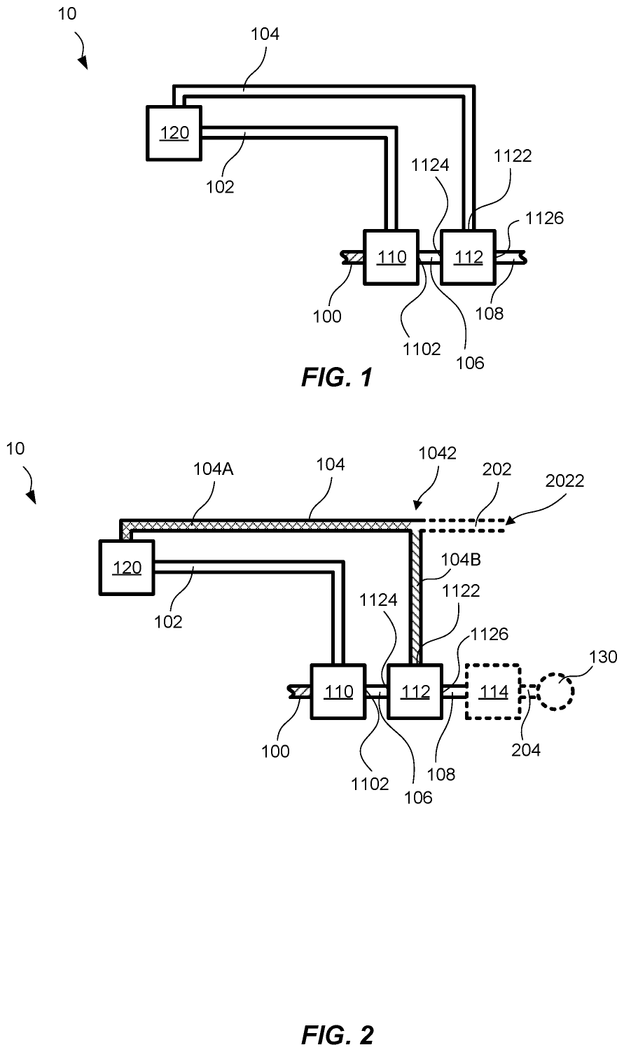

FIG. 1 illustrates a first variant of a microfluidic system 10 according to the present inventive concept. As is illustrated in FIG. 1, the microfluidic system 10 comprises a first sample channel 100, a buffer reservoir 120, a timing channel 102, a buffer channel 104, a mixture channel 106, a first valve 110, a second valve 112, and a first exit channel 108.

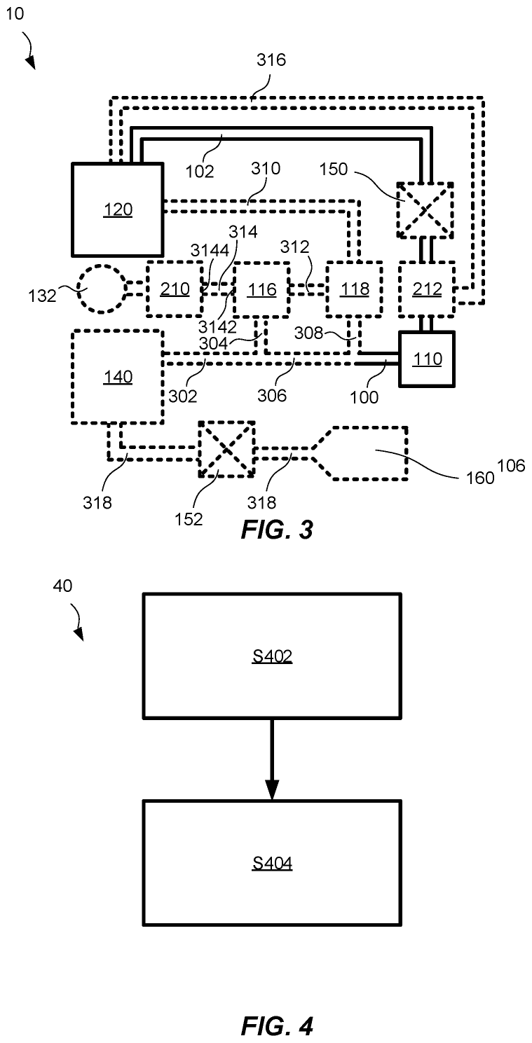

The first sample channel 100 ends in the first valve 110. The first sample channel 100 is arranged to contain a sample liquid of a predetermined volume. The microfluidic system 10 may receive the sample liquid of the predetermined volume from a different system. The microfluidic system 10 may comprise further channels and valves that allow the microfluidic system 10 to meter the sample liquid of the predetermined volume. Such features are illustrated in, and will be described in connection to, FIG. 3.

The buffer reservoir 120 is arranged for receiving a buffer liquid. The buffer reservoir 120 may be arranged for receiving the buffer liquid by having an opening. The buffer liquid may be manually added to the buffer reservoir 120 through the opening. A buffer container (not illustrated in FIG. 1) may be connected to the buffer reservoir 120. The buffer container may contain the buffer liquid and be arranged such that the buffer liquid is added to the buffer reservoir 120 upon a manual input. The manual input may, e.g., be that a layer (e.g., a plastic) of the buffer container is pierced, whereby buffer liquid is added to the buffer reservoir 120.

The timing channel 102 connects the buffer reservoir 120 and the first valve 110. The timing channel 102 is arranged to draw, by capillary action, buffer liquid from the buffer reservoir 120 to an output 1102 of the first valve 110 and to open the first valve 110, whereby sample liquid present in the first sample channel 100 is allowed to flow through the output 1102 of the first valve 110 together with buffer liquid from the timing channel 102. A degree of dilution of the sample by buffer liquid may, at a point when it flows through the output 1102 of the first valve 110, be determined by relative flow rates of the first sample channel 100 and the timing channel 102.

The buffer channel 104 connects the buffer reservoir 120 and the second valve 112. The buffer channel 104 is arranged to draw, by capillary action, buffer liquid from the buffer reservoir 120 to a first opening 1122 of the second valve 112.

The mixture channel 106 connects the first valve 110 and the second valve 112. The mixture channel 106 is arranged to draw, by capillary action, liquid from the first valve 110 to a second opening 1124 of the second valve 112. A volume of the mixture channel 106 may be greater than the predetermined volume.

The first exit channel 108 is connected to a third opening 1126 of the second valve 112. The second valve 112 is arranged to be opened when liquid has been drawn to the first opening 1122 or the second opening 1124 of the second valve 112, whereby liquid is allowed to flow between the first opening 1122, the second opening 1124, and the third opening 1126 of the second valve 112, thereby allowing the sample liquid of the predetermined volume to be diluted with buffer liquid.

At a point when the buffer reservoir 120 has received buffer liquid, buffer liquid is drawn to the first valve 110 via the timing channel 102, and to the second valve 112 via the buffer channel 104.

The microfluidic system 10 may be configured such that buffer liquid reaches the first valve 110 prior to buffer liquid reaches the second valve 112. Put differently, the microfluidic system 10 may be configured such that the first valve 110 is opened prior to buffer liquid reaching the second valve 112. Thus, the microfluidic system 10 may be configured such that, at a point where buffer liquid reaches the second valve 112, the sample diluted at the first valve 110 has flown through the output 1102 of the first valve 110 and into the mixture channel 106. The second valve 112 may be configured to stop the flow through the mixture channel 106. Hence, the diluted sample liquid may be stopped at the second valve 112, and at a point when buffer liquid reaches the second valve 112 via the buffer channel 104, the second valve 112 may be opened and allow the stopped and diluted sample liquid to flow through the second valve 112 and be further diluted with buffer liquid from the buffer channel 104. Alternatively, the microfluidic system 10 may be configured such that the diluted sample liquid reaches the second valve 112 prior to the buffer liquid, and the second valve 112 may be configured to be opened by liquid flow from the mixture channel 106. Put differently, the second valve 112 may be configured to stop the buffer liquid from the buffer channel 104, while the microfluidic system 10 may be configured to open the second valve 112 prior to the buffer liquid reaching the second valve 112. Hence, the diluted sample liquid may be allowed to flow through the second valve 112 (e.g., to the exit channel 108), and is joined afterwards by the buffer liquid from the buffer channel 104 at a point when the buffer liquid reaches the second valve 112.

The microfluidic system 10 may be configured such that buffer liquid reaches the second valve 112 prior to buffer liquid reaches the first valve 110. Put differently, the microfluidic system 10 may be configured such that the first valve 110 is opened subsequent to buffer liquid reaching the second valve 112. The microfluidic system 10 may be configured such that buffer liquid reaches the second valve 112 prior to the diluted sample liquid reaches the second valve 112. The second valve 112 may be configured to stop liquid flow from the buffer channel 104. Hence, when the first valve 110 is opened and diluted sample liquid flows through the output 1102 of the first valve 110, buffer liquid may have reached, and be stopped by, the second valve 112. When the diluted sample liquid reaches the second valve 112, the second valve 112 may be opened and allow the diluted sample liquid to flow through the second valve 112 and be further diluted with buffer liquid from the buffer channel 104. Alternatively, the microfluidic system 10 may be configured such that the buffer liquid reaches the second valve 112 prior to the diluted sample liquid, and the second valve 112 may be configured to be opened by liquid flow from the buffer channel 104. Put differently, the second valve 112 may be configured to stop the diluted sample liquid from the mixture channel 106, while the microfluidic system 10 may be configured to open the second valve 112 prior to the diluted sample liquid reaching the second valve 112. Hence, the buffer liquid may be allowed to flow through the second valve 112 (e.g., to the exit channel 108), and may be joined afterwards by the diluted sample liquid from the mixture channel 106 at a point when the diluted sample liquid reaches the second valve 112.

Put differently, the sample liquid of the predetermined volume is allowed to be diluted with buffer liquid to a high extent while flow rates of one or more of the channels connecting to the first and second valves 110, 112 are allowed to be low enough for the first and second valves 110, 112 to function properly.

As is understood from the above description, the sample liquid of the predetermined volume is mixed with buffer liquid in two instances. The first mixing occurs at the first valve 110, and the dilution ratio at this point may be determined by relative flow rates of the first sample channel 100 and the timing channel 102. Where the second mixing occurs depends on the configuration of the second valve 112, and the relative flow rates of the mixture channel 106, the buffer channel 104 and the first exit channel 108.

In a first variant, the second valve 112 may be further configured, in its open state, to allow liquid from the mixture channel 106 to mix with buffer liquid from the buffer channel 104 and to flow to the first exit channel 108. Hence, in this variant, the microfluidic system 10 outputs sample liquid mixed with buffer liquid via the first exit channel 108.

A second variant will be described with reference to FIG. 2. As illustrated in FIG. 2, the microfluidic system 10 may further comprise an outlet channel 202 connecting an outlet point 1042 of the buffer channel 104 to an outlet 2022. The outlet point 1042 of the buffer channel 104 may be between the buffer reservoir 120 and the second valve 112. In the second variant, the second valve 112 may be configured, in its opened state, to allow diluted sample liquid from the mixture channel 106 to flow to the outlet channel 202 via the buffer channel 104. Hence, in this second variant, the second mixing (i.e., the mixing of diluted sample liquid with further buffer liquid) may predominantly occur at the outlet point 1042 of the buffer channel 104. In other words, the second valve 112 together with one or more dimensions (e.g., one or more cross-sectional dimensions) of the mixture channel 106, the buffer channel 104, the first exit channel 108 (if present), and the outlet channel 202 may be configured such that liquid from the mixture channel 106 flows, when the second valve 112 is in its open state, to the outlet channel 202 via the buffer channel 104. In this second variant, the microfluidic system 10 may output diluted sample liquid mixed with further buffer liquid via the outlet channel 202. It is to be understood that, at a point when buffer liquid has reached the outlet point 1042, e.g., when buffer liquid is drawn to the second valve 112, buffer liquid may flow to the outlet 2022 via the outlet channel 202.

The microfluidic system 10 may be configured such that diluted sample liquid from the mixture channel 106 reaches the second valve 112 prior to buffer liquid from the buffer channel 104 reaches the second valve 112. The second valve 112 may be configured to stop the flow through the mixture channel 106. Hence, the diluted sample liquid may be stopped at the second valve 112, and at a point when buffer liquid reaches the second valve 112 via the buffer channel 104, the second valve 112 may be opened and allow the stopped and diluted sample liquid to flow through the second valve 112 to the outlet channel 202 via the buffer channel 104. Alternatively, the microfluidic system 10 may be configured such that buffer liquid from the buffer channel 104 reaches the second valve 112 prior to the diluted sample liquid from the mixture channel 106 reaches the second valve 112. The second valve 112 may be configured to stop liquid flow from the buffer channel 104. Hence, buffer liquid may be stopped at the second valve 112. When the diluted sample liquid reaches the second valve 112, the second valve 112 may be opened and the diluted sample liquid may flow through the second valve 112 to the outlet channel 202 via the buffer channel 104.

As is illustrated in the example of FIG. 2, the buffer channel 104 may comprise a first portion 104A and a second portion 104B. The first portion 104A of the buffer channel 104 may extend between the buffer reservoir 120 and the outlet point 1042 of the buffer channel 104. The second portion 104B of the buffer channel 104 may extend between the second valve 112 and the outlet point 1042 of the buffer channel 104. A flow resistance of the first portion 104A may be between 0.1 and 0.9 times a flow resistance of the second portion 104B. Since the flow resistance of the first portion 104A may be lower than the flow resistance of the second portion 104B, a flow rate of liquid in the buffer channel 104 when it reaches the second valve 112 may be low enough for the second valve 112 to function properly (i.e., stopping liquid flow from the buffer channel 104) while, at the same time, allowing for a higher flow rate of liquid in the first portion 104A (since the first portion 104A is connected to the outlet channel 202). For example, the flow rate in the first portion 104A may exceed the flow rate at which the second valve 112 cannot stop the liquid flow from the second portion 104B of the buffer channel 104. This may, in turn, allow for an even higher dilution when sample liquid is mixed with buffer liquid at the outlet point 1042 and output to the outlet channel 202.

As is illustrated in the example of FIG. 2, the microfluidic system 10 may further comprise the first exit channel 108. The first exit channel 108 may connect the second valve 112 to a third valve 114, and the third valve 114 may be connected to a first vent 130. The third valve 114 may be connected to the first vent 130 via a valve channel 204. The first vent 130 may be arranged to allow gaseous communication between the third valve 114 and surroundings of the microfluidic system 10 such that gas present in the first exit channel 108 may be allowed to escape. The third valve 114 may be a stop valve. The third valve 114 may be configured to stop liquid flow from the first exit channel 108, which may improve liquid flow from the second valve 112 (when the second valve 112 is in its opened state) to the outlet point 1042 of the buffer channel 104 such that a larger portion of the liquid flows towards the outlet point 1042. Thus, in case the second valve 112 is configured to stop the flow through the mixture channel 106 and to be opened by buffer liquid from the buffer channel 104, and buffer liquid reaches the second valve 112 prior to the diluted sample liquid, buffer liquid from the buffer channel 104 may flow through the second valve 112 and be stopped at the third valve 114. Then, when the diluted sample liquid from the mixture channel 106 reaches the second valve 112, the diluted sample liquid may flow through the second valve 112 to the outlet channel 202. Further, in case the second valve 112 is configured to stop the flow through the buffer channel 104 and to be opened by liquid from the mixture channel 106, and the diluted sample liquid reaches the second valve 112 prior to buffer liquid from the buffer channel 104, the diluted sample liquid from the mixture channel 106 may flow through the second valve 112 and be stopped at the third valve 114. Then, when buffer liquid from the buffer channel 104 reaches the second valve 112, the diluted sample liquid may flow through the second valve 112 to the outlet channel 202.

The microfluidic system 10 may further comprise the features illustrated in FIG. 3. In FIG. 3, some of the features discussed in connection with FIG. 1 and FIG. 2 have been excluded for the sake of readability. For instance, the buffer channel 104, the mixture channel 106, the first exit channel 108, the outlet channel 202, the second valve 112, the third valve 114, and the first vent 130 are not illustrated. However, as will be understood from the following, by comprising the features illustrated in FIG. 3, the microfluidic system 10 may be allowed to meter sample liquid of a predetermined volume.

As illustrated in the example of FIG. 3, the microfluidic system 10 may comprise a sample reservoir 140 arranged for receiving a sample liquid. The sample reservoir 140 may be arranged to receive the sample liquid by having an opening. The skilled person realizes that there are several different manners in which the sample liquid may be added to the sample reservoir 140. The sample liquid may, e.g., be added manually.

As illustrated in FIG. 3, the microfluidic system 10 may further comprise a second sample channel 302 connected to the sample reservoir 140. The second sample channel 302 may branch off into a third sample channel 304 and into a fourth sample channel 306. The third sample channel 304 may end in a fourth valve 116. The fourth sample channel 306 may branch off into a fifth sample channel 308 and into the first sample channel 100. The fifth sample channel 308 may end in a fifth valve 118. As discussed previously in connection with FIG. 1 and FIG. 2, the first sample channel 100 ends in the first valve 110.

As illustrated in FIG. 3, the microfluidic system 10 may further comprise a first trigger channel 310 arranged to connect the buffer reservoir 120 to the fifth valve 118, a second trigger channel 312 connecting the fifth valve 118 and the fourth valve 116, and a second exit channel 314 having a first end and a second end. The first end of the second exit channel 314 may be connected to the fourth valve 116.

The second sample channel 302 may be arranged to draw sample liquid from the sample reservoir 140 to fill the second, third, fourth, fifth, and first sample channels 302, 304, 306, 308, 100 by capillary action. The flows of sample liquid may be stopped by the first valve 110, the fourth valve 116, and the fifth valve 118. Put differently, when sample liquid reaches the first valve 110, the fourth valve 116 and the fifth valve 118, the valves may be in their closed states.

The first trigger channel 310 may be arranged to draw buffer liquid from the buffer reservoir 120, by capillary action, to the second exit channel 314 via a fluid path comprising the second trigger channel 312, and to open the fifth valve 118 and the fourth valve 116, whereby a further fluid path comprising the fifth sample channel 308, the fourth sample channel 306, and the third sample channel 304 may be opened up.

The opened up further fluid path may allow for sample present in the fifth sample channel 308, the fourth sample channel 306, and the third sample channel 304 to be replaced by buffer liquid from the first trigger channel 310 and flow into the second exit channel 314 together with buffer liquid from the second trigger channel 312, whereby a sample liquid present in the first sample channel 100 may be isolated from adjacent sample liquid.

The first sample channel 100 and/or the second sample channel 302 may be adapted, e.g. by adapting their respective geometries (e.g., cross-sectional dimensions and/or shapes), such that capillary forces (or capillary pressures) prevent sample fluid present in the first sample channel 100 and/or the second sample channel 302 to flow towards the second exit channel 314.

One or more of the third sample channel 304, the fourth sample channel 306, the fifth sample channel 308, the first trigger channel 310, the second trigger channel 312 and the second exit channel 314 may be adapted, e.g. by adapting their respective geometries (e.g., cross-sectional dimensions and/or shapes), such that sample fluid present in the third sample channel 304, the fourth sample channel 306 and the fifth sample channel 308 may be replaced by buffer fluid from the first trigger channel 310 and to flow into second exit channel 314 together with buffer fluid from the second trigger channel 312.

A volume of the isolated sample liquid may correspond to the volume of the first sample channel 100, whereby the first sample channel 100 may receive the sample liquid of the predetermined volume. The predetermined volume may be the volume of the first sample channel 100.

Hence, a single microfluidic system 10 capable of metering a sample liquid of a predetermined volume and diluting the metered sample liquid of the is allowed. In particular, the microfluidic system 10 illustrated in FIG. 3 may isolate the sample fluid having the predetermined sample volume from adjacent sample fluid in the microfluidic system 10, without actively controlling the flows within the microfluidic system 10.

It is further to be understood that the microfluidic system 10 may be configured such that the sample fluid having the predetermined volume may be isolated in the first sample channel 100 prior to the dilution processes discussed in connection with FIG. 1 and FIG. 2 are initiated. This may be realized by adapting the timing channel 102, e.g. by adapting its geometry (e.g., cross-sectional dimensions and/or shape), such that the sample liquid of the predetermined volume is isolated/contained in the first sample channel 100 prior to buffer liquid reaching the first valve 110. In case the second valve 112 is configured to be opened upon receiving buffer liquid from the buffer channel 104, the buffer channel 104 may be adapted such that buffer liquid from the buffer channel 104 reaches the second valve 112 subsequent to the diluted sample liquid reaching the second valve 112. In case the second valve 112 is configured to stop liquid flow from the buffer channel 104, the buffer channel 104 may be filled with buffer liquid prior to the first valve 110 being opened, and, optionally, prior to the sample liquid of the predetermined volume is isolated/contained in the first sample channel 100.

The timing channel 102 may be configured to open the first valve 110 subsequent to the sample liquid present in the first sample channel 100 being isolated from adjacent sample liquid. A skilled person realizes that this may require the length and/or flow resistance to be high and it is thus difficult to combine to high mixing ratio at the output of the first valve. The timing channel 102 may be further configured to open the first valve 110 subsequent to sample fluid and buffer fluid reaching the second end of the second exit channel 314.

As illustrated in the example of FIG. 3, the timing channel 102 may comprise a first flow resistor 150. A flow resistance of the first flow resistor 150 may be selected to control the flow rate from the buffer reservoir 120 to the first valve 110 such that the first valve 110 may be opened subsequent to sample liquid in the first sample channel 100 being isolated from adjacent sample liquid. Additionally, the flow resistance of the first flow resistor 150 may be selected to control the flow rate from the buffer reservoir 120 to the first valve 110 such that the first valve 110 may be opened subsequent to sample fluid and buffer fluid reaching the second end of the exit channel. Thus, a length and/or a flow resistance of the timing channel 102 may be decreased, while still allowing for the first valve 110 to be opened subsequent to the sample fluid in the first sample channel 100 being isolated from adjacent sample fluid.

As shown in the example of FIG. 3, the microfluidic system 10 may further comprise a capillary pump 160 arranged to empty the sample reservoir 140. The capillary pump 160 may be arranged to empty the sample reservoir 140 subsequent to the first, second, third, fourth, and fifth sample channels 100, 302, 304, 306, 308 being filled with sample fluid. The capillary pump 160 may be a paper pump and/or a microfluidic channel structure configured to draw liquid from the sample reservoir 140. During emptying of the sample reservoir 140 by the capillary pump 160, capillary pressures or capillary forces in the first sample channel 100, in the third sample channel 304, and in the fifth sample channel 308 may counteract drawing of sample fluid from the first sample channel 100, the second sample channel 302, the third sample channel 304, the fourth sample channel 306, and the fifth sample channel 308 in a direction towards the sample reservoir 140. The capillary pressures or capillary forces in the first sample channel 100, in the third sample channel 304, and in the fifth sample channel 308 may be higher than the capillary pressure or capillary force generated by the capillary pump 160, thereby avoiding emptying the first sample channel 100, the third sample channel 304, and the fifth sample channel 308. The sample reservoir 140 may thereby receive sample fluid having a larger volume than a combined volume of the first, second, third, fourth, and fifth sample channel 308, thereby reducing a need to limit the volume of the sample fluid received by the sample reservoir 140. In case sample fluid is present in the sample reservoir 140 subsequent to filling the first, second, third, fourth, and fifth sample channel 308, additional sample fluid may be drawn by capillary action from the sample reservoir 140 upon opening the first, the fourth, and/or the fifth valves 110, 116, 118. Emptying the sample reservoir 140 from fluid subsequent to filling the first, second, third, fourth, and fifth sample channel 100, 302, 304, 306, 308, allows a capillary pressure or capillary force at an interface between sample fluid in the second sample channel 302 and the sample reservoir 140 to counteract drawing of sample fluid from the second sample channel 302 in a direction from the sample reservoir 140. The second sample channel 302 may be configured to prevent sample fluid from being drawn from the second sample channel 302 towards the sample reservoir 140.

The capillary pump 160 may be connected to the sample reservoir 140 via a second flow resistor 152. A flow resistance of the second flow resistor 152 may be selected to control the flow rate from the sample reservoir 140 to the capillary pump 160 such that the sample reservoir 140 may be emptied subsequent to the first sample channel 100, the second sample channel 302, the third sample channel 304, the fourth sample channel 306, and the fifth sample channel 308 being filled with sample fluid. The capillary pump 160 may be connected to the sample reservoir 140 via a pump capillary channel 318, and the pump capillary channel 318 may comprise the second flow resistor 152.

The microfluidic system 10 may further comprise a stop valve 210 connected to the second end of the second exit channel 314.

The microfluidic system 10 may further comprise a second vent 132 connected to the stop valve 210. The second vent 132 may be arranged to allow gaseous communication between the stop valve 210 and surroundings of the microfluidic system 10 such that gas present in the second exit channel 314 may be allowed to escape. Gas present in one or more of the second sample channel 302, the third sample channel 304, the fourth sample channel 306, the fifth sample channel 308, the first trigger channel 310, and the second trigger channel 312 may be allowed to escape through the second vent 132 via the second exit channel 314. Additionally, gas present in one or more of the first sample channel 100, the second sample channel 302, the third sample channel 304, the fourth sample channel 306, the fifth sample channel 308, the first trigger channel 310, and the second trigger channel 312 may be allowed to escape through the output 1102 of the first valve 110. In case the microfluidic system 10 comprises the first vent 130 connected to the third valve 114, the gas escaping through the output 1102 of the first valve 110 may escape through the first vent 130 connected to the third valve 114. Gas present in the channels may result in a build-up of gaseous pressure in the channels, which may act against the flow of liquid in the channels by capillary action. By allowing gas to escape, such build-up may be avoided, thereby allowing for an improved flow of the liquids in the microfluidic system 10.

One or more walls of the channels may comprise one or more of: silica, glass, a polymeric material, polycarbonate, silicon, poly(methyl methacrylate) (PMMA), polydimethylsiloxane (PDMS), and cyclic olefin copolymer (COC). The channels of the microfluidic system 10 may be comprised in a substrate comprising silica. The silica may be in form of fused silica.

The timing channel 102 may connect the buffer reservoir 120 and the first valve 110 via a sixth valve 212. The microfluidic system 10 may further comprise a dilution channel 316 connecting the buffer reservoir 120 and the sixth valve 212. The dilution channel 316 may be configured to draw, by capillary action, buffer liquid from the buffer reservoir 120 to the sixth valve 212. The timing channel 102 may be further configured to open the sixth valve 212, whereby buffer liquid may be allowed to flow from the dilution channel 316 to the first valve 110. Thus, the sixth valve 212 may, in its open state, be configured to allow buffer fluid to flow from the dilution channel 316 to the first valve 110. A ratio of sample liquid exiting the output 1102 of the first valve 110 relative to buffer fluid may thereby be controlled by adjusting the flow resistances (or flow rates) of one or more of the timing channel 102, the first flow resistor 150, the dilution channel 316, the first trigger channel 310, the second trigger channel 312, the first sample channel 100, the third sample channel 304, the fourth sample channel 306, and the fifth sample channel 308.

The concept of metering a sample fluid having a predetermined volume using a microfluidic system 10 similar to the one illustrated in FIG. 3 is described in detail in international (PCT) application PCT/EP2021/054166, in particular in connection with the discussion in connection to FIG. 2A-2E of that application.

It is to be understood that the microfluidic system 10 discussed in connection with FIG. 1, FIG. 2, and/or FIG. 3 may form part of a diagnostic device (not illustrated in the figures). Such diagnostic device may be arranged to analyze the diluted sample liquid. The diagnostic device may be arranged to analyze the diluted sample liquid by comprising an analysis system. An input of the analysis system may be fluidically connected to an output of the microfluidic system 10. The output of the microfluidic system 10 may vary, which is discussed in connection with FIG. 1 and FIG. 2. The output of the microfluidic system 10 may, e.g., be the first exit channel 108 and/or the outlet channel 202. The analysis system may comprise vents allowing for gaseous communication between the analysis system and its surroundings and/or between the analysis system and the surroundings of the diagnostic device, in order to avoid build-up of gaseous pressure in the microfluidic system 10 and/or the analysis system.

It is further to be understood that the microfluidic system 10 of FIG. 1 and/or FIG. 2 may be used in a method for diluting a sample liquid of a predetermined sample volume. The method comprises providing the sample liquid of the predetermined volume to a first sample channel 100, wherein the first sample channel 100 ends in a first valve 110. The method further comprises providing a buffer liquid to a buffer reservoir 120, whereby buffer liquid is drawn, by capillary action, from the buffer reservoir 120 via a buffer channel 104 to a first opening 1122 of a second valve 112, and from the buffer reservoir 120 via a timing channel 102 to the first valve 110, wherein the first valve 110 is opened by the buffer liquid and whereby the sample liquid of the predetermined volume and the buffer liquid flow to a second opening 1124 of the second valve 112 via a mixture channel 106, wherein the second valve 112 is opened upon receiving liquid at the first opening 1122 or the second opening 1124, whereby liquid communication is allowed between the first opening 1122, the second opening 1124, and a third opening 1126 of the second valve 112, thereby allowing the sample liquid of the predetermined volume to be diluted with buffer liquid.

The person skilled in the art realizes that the present inventive concept by no means is limited to the preferred variants described above. On the contrary, many modifications and variations are possible within the scope of the appended claims. Additionally, variations to the disclosed variants can be understood and effected by the skilled person in practicing the claimed invention, from a study of the drawings, the disclosure, and the appended claims.

1. A microfluidic system (10) for diluting a sample liquid of a predetermined sample volume, the system (10) comprising:
a first sample channel (100) ending in a first valve (110), wherein the first sample channel (100) is arranged to contain the sample liquid of the predetermined volume;
a buffer reservoir (120) arranged for receiving a buffer liquid;
a timing channel (102) connecting the buffer reservoir (120) and the first valve (110), wherein the timing channel (102) is arranged to draw, by capillary action, buffer liquid from the buffer reservoir (120) to an output (1102) of the first valve (110) and to open the first valve (110), whereby sample liquid present in the first sample channel (100) is allowed to flow through the output (1102) of the first valve (110) together with buffer liquid from the timing channel (102);
a buffer channel (104) connecting the buffer reservoir (120) and a second valve (112), wherein the buffer channel (104) is arranged to draw, by capillary action, buffer liquid from the buffer reservoir (120) to a first opening (1122) of the second valve (112);
a mixture channel (106) connecting the first valve (110) and the second valve (112), wherein the mixture channel (106) is arranged to draw, by capillary action, liquid from the first valve (110) to a second opening (1124) of the second valve (112); and
an outlet channel (202) connecting an outlet point (1042) of the buffer channel (104) to an outlet (2022), wherein the outlet point (1042) of the buffer channel (104) is between the buffer reservoir (120) and the second valve (112);
wherein the second valve (112) is arranged to be opened when liquid has been drawn to the first opening (1122) or the second opening (1124) of the second valve (112), whereby liquid from the mixture channel (106) flows to the outlet channel (202) via the buffer channel (104), thereby diluting the sample liquid of the predetermined volume with buffer liquid.

2. The microfluidic system (10) according to claim 1, further comprising:
a first exit channel (108) connected to a third opening (1126) of the second valve (112).

3. The microfluidic system (10) according to claim 2, wherein the first exit channel (108) connects the second valve (112) to a third valve (114), wherein the third valve (114) is connected to a first vent (130),
wherein the first vent (130) is arranged to allow gaseous communication between the third valve (114) and surroundings of the microfluidic system (10) such that gas present in the first exit channel (108) is allowed to escape.

4. The microfluidic system (10) according to claim 1, wherein the buffer channel (104) comprises:
a first portion (104A) extending between the buffer reservoir (120) and the outlet point (1042) of the buffer channel (104); and
a second portion (104B) extending between the second valve (112) and the outlet point (1042) of the buffer channel (104);
wherein a flow resistance of the first portion (104A) is between 0.1 and 0.9 times a flow resistance of the second portion (104B).

5. The microfluidic system (10) according to claim 1, further comprising:
a sample reservoir (140) arranged for receiving a sample liquid;
a second sample channel (302) connected to the sample reservoir (140), the second sample channel (302) branching off into a third sample channel (304) ending in a fourth valve (116), and into a fourth sample channel (306), the fourth sample channel (306) branching off into a fifth sample channel (308) ending in a fifth valve (118), and into the first sample channel (100);
a first trigger channel (310) arranged to connect the buffer reservoir (120) to the fifth valve (118);
a second trigger channel (312) connecting the fifth valve (118) and the fourth valve (116); and
a second exit channel (314) having a first end (3142) and a second end (3144), wherein the first end (3142) is connected to the fourth valve (116);
wherein the second sample channel (302) is arranged to draw sample liquid from the sample reservoir (140) to fill the second, third, fourth, fifth, and first sample channels (302, 304, 306, 308, 100) by capillary action;
wherein the first trigger channel (310) is arranged to draw buffer liquid from the buffer reservoir (120), by capillary action, to the second exit channel (314) via a fluid path comprising the second trigger channel (312), and to open the fifth valve (118) and the fourth valve (116), whereby a further fluid path comprising the fifth sample channel (308), the fourth sample channel (306), and the third sample channel (304) is opened up, allowing for sample present in the fifth sample channel (308), the fourth sample channel (306), and the third sample channel (304) to be replaced by buffer liquid from the first trigger channel (310) and flow into the second exit channel (314) together with buffer liquid from the second trigger channel (312), thereby isolating a sample liquid present in the first sample channel (100) from adjacent sample liquid, wherein a volume of the isolated sample liquid corresponds to the volume of the first sample channel (100), whereby the first sample channel (100) receives the sample liquid of the predetermined volume.

6. The microfluidic system (10) according to claim 5, wherein the timing channel (102) is configured to open the first valve (110) subsequent to the sample liquid present in the first sample channel (100) being isolated from adjacent sample liquid.

7. The microfluidic system (10) according to claim 5, wherein the timing channel (102) comprises a first flow resistor (150), wherein a flow resistance of the first flow resistor (150) is selected to control the flow rate from the buffer reservoir (120) to the first valve (110) such that the first valve (110) is opened subsequent to sample liquid in the first sample channel (100) being isolated from adjacent sample liquid.

8. The microfluidic system (10) according to claim 5, further comprising:
a capillary pump (160) arranged to empty the sample reservoir (140).

9. The microfluidic system (10) according to claim 8, wherein the capillary pump (160) is connected to the sample reservoir (140) via a second flow resistor (152), wherein a flow resistance of the second flow resistor (152) is selected to control the flow rate from the sample reservoir (140) to the capillary pump (160) such that the sample reservoir (140) is emptied subsequent to the second sample channel (302), the third sample channel (304), the fourth sample channel (306), the fifth sample channel (308), and the first sample channel (100) being filled with sample fluid.

10. The microfluidic system (10) according to claim 5, further comprising:
a stop valve (210) connected to the second end (3144) of the second exit channel (314).

11. The microfluidic system (10) according to claim 10, further comprising:
a second vent (132) connected to the stop valve (210), wherein the second vent (132) is arranged to allow gaseous communication between the stop valve (210) and surroundings of the microfluidic system (10) such that gas present in the second exit channel (314) is allowed to escape.

12. The microfluidic system (10) according to claim 1, wherein one or more walls of the channels comprises one or more of: silica, glass, a polymeric material, polycarbonate, silicon, poly(methyl methacrylate) (PMMA), polydimethylsiloxane (PDMS), and cyclic olefin copolymer (COC).

13. The microfluidic system (10) according to claim 1, wherein the timing channel (102) connects the buffer reservoir (120) and the first valve (110) via a sixth valve (212), the microfluidic system (10) further comprising:
a dilution channel (316) connecting the buffer reservoir (120) and the sixth valve (212), the dilution channel (316) being configured to draw, by capillary action, buffer liquid from the buffer reservoir (120) to the sixth valve (212); and
wherein the timing channel (102) is further configured to open the sixth valve (212), whereby buffer liquid is allowed to flow from the dilution channel (316) to the first valve (110).

14. A diagnostic device (50) comprising a microfluidic system (10) of claim 1.

15. A method (40) for diluting a sample liquid of a predetermined sample volume, the method comprising:
providing (S400) the sample liquid of the predetermined volume to a first sample channel (100), wherein the first sample channel (100) ends in a first valve (110); and
providing (S402) a buffer liquid to a buffer reservoir (120), whereby buffer liquid is drawn, by capillary action, from the buffer reservoir (120) via a buffer channel (104) to a first opening (1122) of a second valve (112), and from the buffer reservoir (120) via a timing channel (102) to the first valve (110), wherein the first valve (110) is opened by the buffer liquid and whereby the sample liquid of the predetermined volume and the buffer liquid flow to a second opening (1124) of the second valve (112) via a mixture channel (106);
wherein the second valve (112) is opened upon receiving liquid at the first opening (1122) or the second opening (1124), whereby liquid from the mixture channel (106) flows via the buffer channel (104) to an outlet channel (202) connected to an outlet point (1042) of the buffer channel (104), thereby diluting the sample liquid of the predetermined volume with buffer liquid.
